(19) United States
(12) Patent Application Publication
(10) Pub. No.: US 2017/0325912 A1
(43) Pub. Date: Nov. 16, 2017

(54) METHOD AND SYSTEM FOR AN ORTHODONTIC DEVICE

(71) Applicant: Jedediah Michael Feller, Las Vegas, NV (US)

(72) Inventor: Jedediah Michael Feller, Las Vegas, NV (US)

(21) Appl. No.: 15/594,217

(22) Filed: May 12, 2017

Related U.S. Application Data
(60) Provisional application No. 62/335,133, filed on May 12, 2016.

(51) Int. Cl. A61C 7/14; A61C 7/18; A61C 7/00; A61C 7/08

(52) U.S. Cl. CPC A61C 7/146; A61C 7/18; A61C 7/002; A61C 7/08; A61C 7/148

(57) ABSTRACT

A method of aligning teeth and an orthodontic appliance are provided. The orthodontic appliance is configured to be adhered to a surface of a tooth and configured to receive a plurality of differently sized archwires. The orthodontic appliance includes a bonding surface configured to be adhered to the surface of the tooth, an opposing outside surface, a plurality of sidewalls extending between the bonding surface and the opposing outside surface, and an archwire groove extending from a sidewall of the plurality of sidewalls parallelly between the bonding surface and the opposing outside surface.

This application claims priority to and the benefit of the filing date of U.S. Provisional Application No. 62/335,133 filed on May 12, 2016, which is hereby incorporated by reference in its entirety.

### BACKGROUND

The field of the disclosure relates generally to orthodontic devices and, more particularly, to a method and system for an orthodontic attachment device, which is capable of receiving archwires of a plurality of sizes.

Orthodontic brackets represent a principal component of corrective orthodontic treatment for improving a patient's occlusion. In orthodontic treatment, an orthodontist affixes brackets to the patient's teeth and engages an archwire into a slot of each bracket. The archwire applies corrective forces that coerce the teeth to move into their aesthetically correct positions. The types of tooth movement desired during orthodontic treatment may vary significantly from the early stage of treatment to the final stage of treatment. The different types of tooth movement desired necessitate fundamentally different approaches for engaging the archwire within the archwire slot.

Self-ligating orthodontic brackets have been developed to eliminate the need for separate ligatures to secure the archwire to the bracket. Self-ligating brackets rely on a movable portion or member, such as a latch or slide, to retain the archwire within the bracket slot.

During the early stages of treatment, a clinician may use an archwire that does not substantially fill the archwire slot. The archwire may, therefore, not be fully seated in the archwire slot during treatment. That is, there may be space between the archwire and two or more opposing surfaces of the archwire slot and/or between the archwire and the movable member. This is often referred to as “passive ligation.” As a result, the archwire may slide or move relative to the bracket in the mesial and/or distal directions, in the labial and/or lingual directions, and/or in the occlusal and/or gingival directions during treatment. Thus, passive ligation may allow gross movement of the teeth. Considerable movement between the archwire and the bracket is possible. It will be appreciated that a relatively small archwire, which may be round in cross section, may be used to facilitate passive ligation and thus provide quicker leveling and aligning of the teeth during an initial stage of treatment.

During a later stage of treatment, it may be desirable to more precisely control the orientation of one or more of the teeth. In this regard, the archwire may be forcibly held or fully seated in contact with the archwire slot by the clip and/or optional ligatures to provide control of rotation on the particular tooth. This is often referred to as “active ligation.” The clinician may use a relatively large archwire, which may be rectangular as opposed to round, to substantially fill the space within the archwire slot. The larger archwire may then contact both the slot and the clip at the same time to enhance the clinician's control of rotation of and torque on the tooth.

While such self-ligating brackets are generally successful in achieving their intended purpose, there remain some drawbacks. By way of example, in some instances controlling the rotation of the teeth, such as near the finishing stages of orthodontic treatment, can be problematic. One such drawback is the looseness of the fit between the archwire and the archwire slot, which may be a result of tolerances of the manufacturing process used to form the bracket body and other members associated with the bracket. The various tolerances may provide for a relatively loose fit between the archwire and the archwire slot. A loose fit may result in a diminished capacity to control the rotation of the teeth. Although known orthodontic brackets have been generally successful, orthodontic appliances that provide improved rotational control during orthodontic treatment, such as during the finishing or the active stage of treatment are needed.

### BRIEF DESCRIPTION

In one aspect, an orthodontic appliance is configured to be adhered to a surface of a tooth and configured to receive a plurality of differently sized archwires. The orthodontic appliance including a bonding surface configured to be adhered to the surface of the tooth, an opposing outside surface, a plurality of sidewalls extending between the bonding surface and the opposing outside surface, and an archwire groove extending from a sidewall of the plurality of sidewalls parallelly between the bonding surface and the opposing outside surface.

In another aspect, a method of aligning teeth includes adhering a plurality of orthodontic appliances to a surface of respective adjacent teeth. Each orthodontic appliance of the plurality of orthodontic appliances includes an archwire groove including at least one archwire stay configured to receive an archwire therein. The method further includes aligning an archwire with openings of the archwire grooves, sliding the archwire laterally into the openings, retaining the archwire in the at least one archwire stay, and adjusting a tension of the archwire to a predetermined amount.

In yet another embodiment, an orthodontic appliance is configured to be adhered to a surface of a tooth and configured to receive a plurality of differently sized archwires. The orthodontic appliance includes a bonding surface configured to be adhered to the surface of the tooth, a surface opposed to said bonding surface, a plurality of sidewalls extending between said bonding surface and said opposing surface, and an archwire groove extending between said plurality of sidewalls, said archwire groove comprising a plurality of archwire stays each having a respective cross section and size.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an orthodontic appliance in accordance with an example embodiment of the present disclosure.

FIG. 2 is a plan view of for example, a lower jaw of a user illustrating a row of teeth of the user.

FIG. 3 is a side elevation view of the orthodontic appliance in accordance with an example embodiment of the present disclosure.

FIG. 4 is a side elevation view of the orthodontic appliance in accordance with another example embodiment of the present disclosure.

FIG. 5 is a flowchart of a method of aligning teeth.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

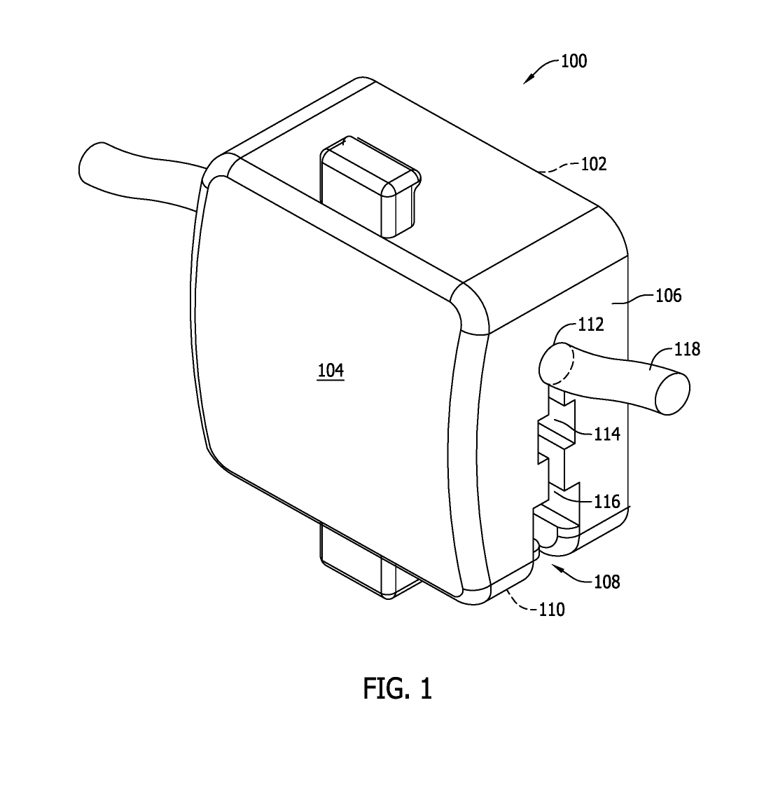

FIG. 1 is a perspective view of an orthodontic appliance 100 in accordance with an example embodiment of the present disclosure. In the example embodiment, orthodontic appliance 100 includes a bonding surface 102 and an opposing face 104 and a body 106 extending therebetween. Bonding surface 102 is configured to be adhered to a surface of a tooth (not shown in FIG. 1). Face 104 is configured to be exposed to an inner oral surface of a mouth of a user. Accordingly, surface 102, face 104, body 106 and other surfaces associated with orthodontic appliance 100 are configured to smooth and generally rounded to prevent catching or cutting into the inner oral surface of the user. Body 106 includes a groove 108 that extends from a lower surface 110 of body 106 parallel between surface 102 and face 104. In the example embodiment, groove 108 includes three archwire stays, a first archwire stay 112, a second archwire stay 114, and a third archwire stay 116. Each of archwire stays 112, 114, and 116 are configured to receive archwires of progressively larger size. Each of archwire stays 112, 114, and 116 are also shaped to be complementary to a shape of an archwire used with that archwire stay 112, 114, or 116. For example, a round archwire 118 is illustrated as fitted into archwire stay 112. However, archwire stay 112 could be shaped differently and archwire 118 could be also shaped to match the different shape of archwire stay 112. Archwire stays 114 and 116 are illustrated as being rectangularly-shaped. Specifically, archwire stays 114 and 116 are illustrated as being square-shaped. In various embodiments, archwire stays 114 and 116 can be shaped in other shapes. A relatively small archwire 118, which may be round in cross section, may be used to facilitate passive ligation and thus provide quicker leveling and aligning of the teeth during an initial stage of treatment. During a later stage of treatment, it may be desirable to more precisely control the orientation of one or more of the teeth. In this regard, archwire 118 may be forcibly held or fully seated in contact with archwire stays 112, 114, or 116 to provide control of rotation on one or more of the particular tooth. This is often referred to as “active ligation.” The clinician may use a relatively large archwire, which may be rectangular as opposed to round, to substantially fill the space within the archwire stays, for example, archwire stays 114 or 116. The larger archwire may then contact all surfaces of archwire stays 114 or 116 at the same time to enhance the clinician's control of rotation of and torque on the tooth.

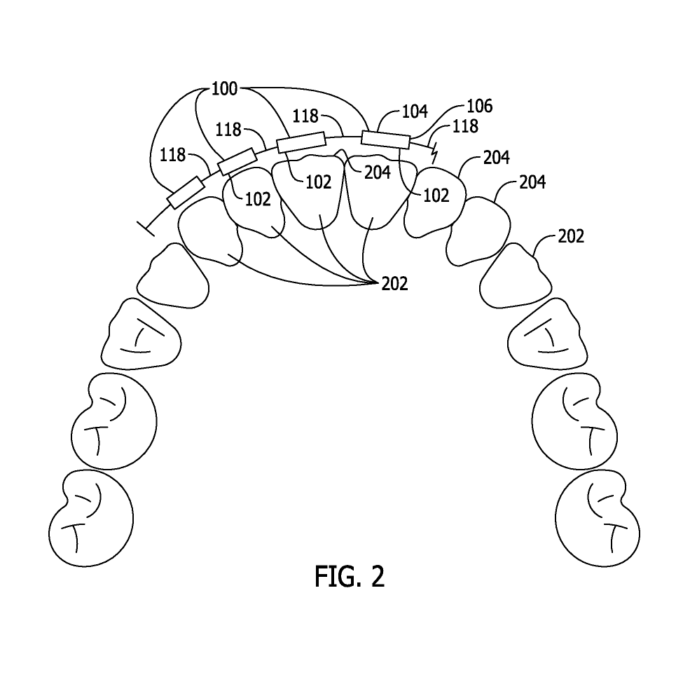

FIG. 2 is a plan view of for example, a lower jaw 200 of a user illustrating a row of teeth 202 of the user. In the example embodiment, orthodontic appliance 100 is adhered to a front surface 204 of one or more of teeth 202. Archwire 118 is illustrated as passing from orthodontic appliance 100 on each tooth 202 to orthodontic appliance 100 on adjacent teeth 202.

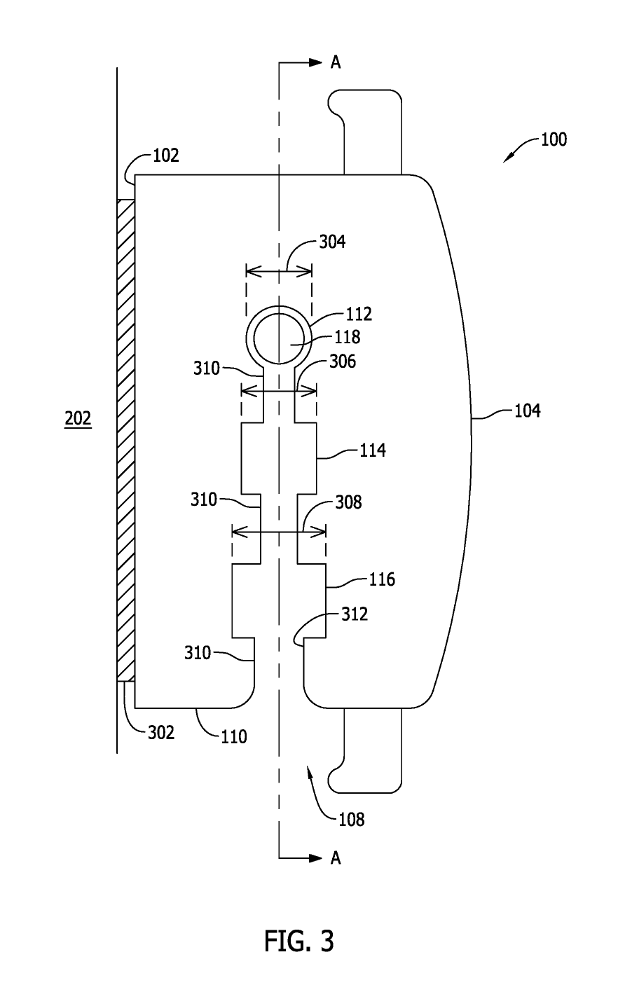

FIG. 3 is a side elevation view of orthodontic appliance 100 in accordance with an example embodiment of the present disclosure. In the example embodiment, orthodontic appliance 100 is adhered to tooth 202 using an adhesive 302. Groove 108 is illustrated with archwire stays 112, 114, and 116. Archwire stay 112 includes a diameter 304 that in some embodiments is approximately 0.009 inches to approximately 0.025 inches. Archwire stay 114 includes a width 306 that is perpendicular to bonding surface 102. In some embodiments, width 306 is a distance that is greater than diameter 304. Archwire stay 116 includes a width 308 that is perpendicular to bonding surface 102. In some embodiments, width 308 is a distance that is greater than width 306. The progressively smaller size of archwire stays 116 to 112 prevents an archwire, such as archwire 118 from being able to fit in an incorrect archwire stay 112, 114, or 116. In various embodiments, channels 310 that connect archwire stays 112, 114, and 116 are sized smaller than archwire stays 112, 114, and 116. To permit archwire 118 to pass through groove 108 to a proper archwire stay of archwire stays 112, 114, and 116, orthodontic appliance 100 includes a resiliency about archwire stay 112 such that groove 108 is able to open slightly when a lateral force is applied to a sidewall 312 of orthodontic appliance 100. The force may be applied by archwire 118 as archwire 118 is inserted into groove 108 and pushed into the proper stay of possible archwire stays 112, 114, and 116. When archwire 118 is positioned within the proper archwire stay 112, 114, or 116, orthodontic appliance 100 resiliently snaps back to its original position.

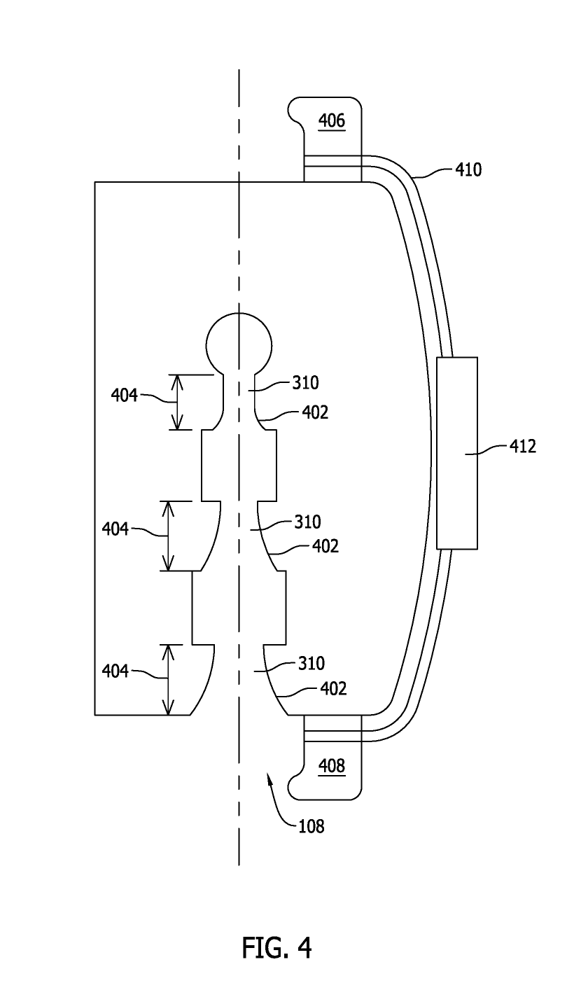

FIG. 4 is a side elevation view of orthodontic appliance 100 in accordance with another example embodiment of the present disclosure. In this example embodiment, one or more of archwire stays 112, 114, and 116 includes a convergent cross-section 402 configured to facilitate guiding archwire 118 through groove 108. In various embodiments, convergent cross-section 402 may extend an entire length 404 of channel 310 or may extend for only a portion of length 404. In the example embodiment, orthodontic appliance 100 also includes one or more accessory attachment tabs 406 and 408. Accessory attachment tabs 406 and 408 are configured to receive, for example, elastic bands 410 used to secure additional devices 412, such as, but not limited to orthodontic appliances and/or entertainment and fashion devices.

Archwire stays 112, 114, and 116 permit changing of archwire 118 during treatment without removing and reinstalling orthodontic appliance 100 to accommodate different sizes of archwire 118. Typically, archwire 118 is changed often during treatment. Treatment involves slowly moving from small archwire 118 that are round in cross-section to relatively heavy thick wires that are rectangularly-shaped. By using different shaped archwire 118, forces acting on tooth 202 can be tailored to move tooth 202 to a predetermined position. When a better alignment of the teeth is accomplished, archwire 118 is changed to a material that can be bent, like stainless steel. Bending a strong archwire 118 permits fine-tuning of the occlusion.

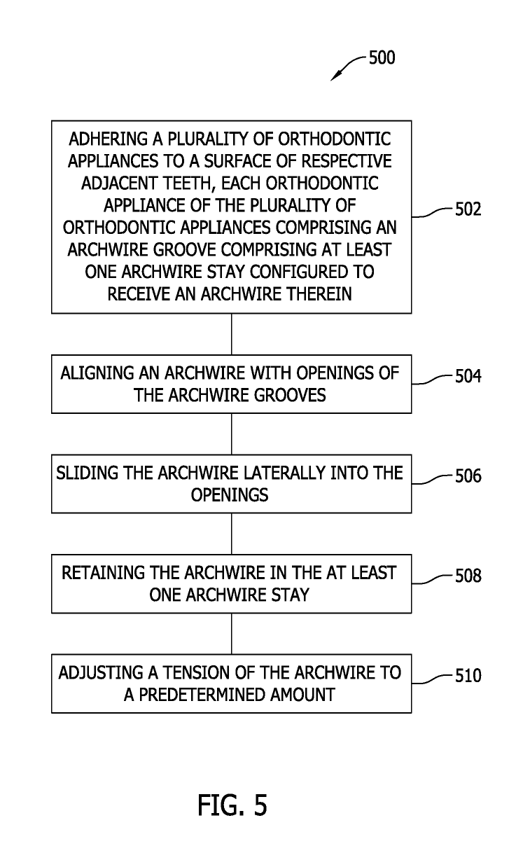

FIG. 5 is a flowchart of a method 500 of aligning teeth. In the example embodiment, method 500 includes adhering 502 a plurality of orthodontic appliances to a surface of respective adjacent teeth wherein each orthodontic appliance of said plurality of orthodontic appliances includes an archwire groove including at least one archwire stay configured to receive an archwire therein. Method 500 also includes aligning 504 an archwire with openings of said archwire grooves, sliding 506 the archwire laterally into said openings, retaining 508 the archwire in said at least one archwire stay, and adjusting 510 a tension of the archwire to a predetermined amount.

Described herein is an orthodontic appliance configured to be adhered to a surface of a tooth and configured to receive a plurality of differently sized archwires. In one embodiment, the orthodontic appliance includes a bonding surface configured to be adhered to the surface of the tooth, an opposing outside surface, a plurality of sidewalls extending between the bonding surface and the opposing outside surface, and an archwire groove extending from a sidewall of the plurality of sidewalls parallelly between the bonding surface and the opposing outside surface. The archwire groove may further include a plurality of archwire stays configured to receive an archwire therein. The archwire groove may further include three archwire stays parallel with respect to each other. Optionally, the archwire groove may further include a first archwire stay having a first cross-sectional shape and a second archwire stay having a second cross-sectional shape. The first and second cross-sectional shapes may be the same or they may be different. The archwire groove may also include at least one converging wall adjacent at least one of the first archwire stay and the second archwire stay. At least one sidewall of the plurality of sidewalls may include an accessory attachment tab extending away from a surface of the at least one sidewall. Optionally, opposing sidewalls of the plurality of sidewalls may each include an accessory attachment tab extending away from a surface of a respective sidewall.

A method of aligning teeth is also described. In the example embodiment, the method includes adhering a plurality of orthodontic appliances to a surface of respective teeth wherein each orthodontic appliance of the plurality of orthodontic appliances includes an archwire groove that includes a plurality of archwire stays. Each of the plurality of archwire stays is configured to receive an archwire sized and shaped complementary to a size and shape of a respective one of the plurality of archwire stays. The method also includes aligning a first archwire with an opening in the archwire grooves, sliding the first archwire laterally into the opening, retaining the first archwire in one of the plurality of archwire stays, and adjusting a tension of the first archwire to a first predetermined amount.

Optionally, at least one of the plurality of orthodontic appliances includes a plurality of archwire stays sized and/or shaped differently from each of the other of the plurality of archwire stays. The plurality of archwire stays may also include an archwire stay having a round cross section or at least one archwire stay having a rectangular cross section. Optionally, the at least one archwire stay may have a rectangular cross section and is configured to receive a rectangular archwire that contacts all interior surfaces of the rectangular archwire stay. The method may also include applying a torque force to at least one of the plurality of orthodontic appliances using the rectangular archwire in the rectangular archwire stay. The method may also include removing the first archwire from the one of the plurality of archwire stays, selecting a second archwire having dimensions complementary to dimensions of a second one of the plurality of archwire stays, retaining the second archwire in the second one of the plurality of archwire stays, and adjusting a tension of the first archwire to a second predetermined amount, the second predetermined amount different than the first predetermined amount. Adjusting a tension of the first archwire to a second predetermined amount may also include adjusting a tension of the first archwire to a second predetermined amount that includes a torque component of force.

An orthodontic appliance is also described herein that is configured to be adhered to a surface of a tooth and configured to receive a plurality of differently sized archwires. The orthodontic appliance further includes a bonding surface configured to be adhered to the surface of the tooth, a surface opposed to the bonding surface, a plurality of sidewalls extending between the bonding surface and the opposing surface, and an archwire groove extending between the plurality of sidewalls, the archwire groove includes a plurality of archwire stays each having a respective cross section and size. Optionally, the archwire groove may extend between the plurality of sidewalls parallelly between the bonding surface and the opposed surface. Also optionally, the archwire groove may include at least one converging wall adjacent at least one of the plurality of archwire stays. At least one sidewall of the plurality of sidewalls may include an accessory attachment tab extending away from a surface of the at least one sidewall.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An orthodontic appliance configured to be adhered to a surface of a tooth and configured to receive a plurality of differently sized archwires, said orthodontic appliance comprising:
a bonding surface configured to be adhered to the surface of the tooth;
an opposing outside surface;
a plurality of sidewalls extending between said bonding surface and said opposing outside surface; and
an archwire groove extending from a sidewall of the plurality of sidewalls parallelly between said bonding surface and said opposing outside surface.

2. The orthodontic appliance of claim 1, wherein said archwire groove further comprises a plurality of archwire stays configured to receive an archwire therein.

3. The orthodontic appliance of claim 2, wherein said archwire groove further comprises three archwire stays parallel with respect to each other.

4. The orthodontic appliance of claim 3, wherein said archwire groove further comprises:
a first archwire stay having a first cross-sectional shape; and
a second archwire stay having a second cross-sectional shape.

5. The orthodontic appliance of claim 4, wherein said first and second cross-sectional shapes are the same.

6. The orthodontic appliance of claim 4, wherein said first and second cross-sectional shapes are different.

7. The orthodontic appliance of claim 4, wherein said archwire groove comprises at least one converging wall adjacent at least one of said first archwire stay and said second archwire stay.

8. The orthodontic appliance of claim 1, wherein at least one sidewall of the plurality of sidewalls comprises an accessory attachment tab extending away from a surface of the at least one sidewall.

9. The orthodontic appliance of claim 1, wherein opposing sidewalls of the plurality of sidewalls each comprise an accessory attachment tab extending away from a surface of a respective sidewall.

10. A method of aligning teeth, said method comprising:
adhering a plurality of orthodontic appliances to a surface of respective teeth, each orthodontic appliance of the plurality of orthodontic appliances comprising an archwire groove comprising a plurality of archwire stays, each of the plurality of archwire stays is configured to receive an archwire sized and shaped complementary to a size and shape of a respective one of the plurality of archwire stays;
aligning a first archwire with an opening in the archwire grooves;
sliding the first archwire laterally into the opening;
retaining the first archwire in one of the plurality of archwire stays; and
adjusting a tension of the first archwire to a first predetermined amount.

11. The method of claim 10, wherein at least one of the plurality of orthodontic appliances comprises a plurality of archwire stays at least one of sized and shaped differently from each of the other of the plurality of archwire stays.

12. The method of claim 11, wherein the plurality of archwire stays comprises at least one archwire stay having a round cross-section and at least one archwire stay having a rectangular cross-section.

13. The method of claim 12, wherein the at least one archwire stay having a rectangular cross-section is configured to receive a rectangular archwire that contacts all interior surfaces of the rectangular archwire stay.

14. The method of claim 13, further comprising applying a torque force to at least one of the plurality of orthodontic appliances using the rectangular archwire in the rectangular archwire stay.

15. The method of claim 10, further comprising:
removing the first archwire from the one of the plurality of archwire stays;
selecting a second archwire having dimensions complementary to dimensions of a second one of the plurality of archwire stays;
retaining the second archwire in the second one of the plurality of archwire stays; and
adjusting a tension of the first archwire to a second predetermined amount, the second predetermined amount different than the first predetermined amount.

16. The method of claim 15, wherein adjusting a tension of the first archwire to a second predetermined amount comprises adjusting a tension of the first archwire to a second predetermined amount that includes a torque component of force.

17. An orthodontic appliance configured to be adhered to a surface of a tooth and configured to receive a plurality of differently sized archwires, said orthodontic appliance comprising:
a bonding surface configured to be adhered to the surface of the tooth;
a surface opposed to said bonding surface;
a plurality of sidewalls extending between said bonding surface and said opposing surface; and
an archwire groove extending between said plurality of sidewalls, said archwire groove comprising a plurality of archwire stays each having a respective cross-section and size.

18. The orthodontic appliance of claim 17, wherein said archwire groove extends between said plurality of sidewalls parallelly between said bonding surface and said opposed surface.

19. The orthodontic appliance of claim 17, wherein said archwire groove comprises at least one converging wall adjacent at least one of said plurality of archwire stays.

20. The orthodontic appliance of claim 17, wherein at least one sidewall of the plurality of sidewalls comprises an accessory attachment tab extending away from a surface of the at least one sidewall.
